(19) United States
(12) Patent Application Publication
(10) Pub. No.: US 2012/0048628 A1
(43) Pub. Date: Mar. 1, 2012

(54) TORQUE DETECTION APPARATUS AND ROBOT APPARATUS

(75) Inventors: Yasunori KAWANAMI, Tokyo (JP); Atsushi Miyamoto, Kanagawa (JP); Toshimitsu Tsuboi, Tokyo (JP); Tetsuharu Fukushima, Tokyo (JP); Kenta Kawamoto, Tokyo (JP); Yasuhide Hosoda, Kanagawa (JP)

(73) Assignee: SONY CORPORATION, Tokyo (JP)

(21) Appl. No.: 13/181,741

(22) Filed: Jul. 13, 2011

(30) Foreign Application Priority Data
Aug. 24, 2010 (JP) 2010-186887

(51) Int. Cl. B25J 5/00; B25J 19/02; G01L 3/10

(52) U.S. Cl. 180/21; 73/862.338; 901/1; 901/46

(57) ABSTRACT

Provided is a torque detection apparatus including a base portion, a drive portion, and a detection portion. The drive portion includes a rotor having a main axis in a direction of a first axis, and a stator configured to rotate the rotor around the main axis. The detection portion includes a strain body and a detection element. The strain body includes a first end portion to be fixed to the base portion and a second end portion to be fixed to the rotor, and is arranged concentrically with the rotor. The detection element is provided to the strain body so as to detect a strain of the strain body around the first axis with respect to the base portion.

### BACKGROUND

The present disclosure relates to a torque detection apparatus for detecting a rotational torque that acts on an infinitely rotating shaft, for example, and to a robot apparatus including the same.

In the related art, as a method of measuring a rotational torque, the following method has been known. Specifically, in this method, between a driving shaft being a detection target and a fixing portion that supports the driving shaft so as to be rotatable, a strain body is provided. By detecting an amount of deformation of the strain body, a rotational torque that acts around the axis of the driving shaft is measured. For example, Japanese patent No. 3136816 below (hereinafter, referred to as Patent Document 1) discloses a robot arm with a torque sensor, which includes an inner ring, an outer ring, and a sensor. The inner ring is coupled to a shaft that is driven by a servo motor and is reduced in speed by a reducer. The outer ring is coupled to a first member of the robot arm. The sensor detects a relative displacement between the inner ring and the outer ring due to a rotational torque. Such a robot arm detects the relative displacement between the inner ring and the outer ring, which is generated during rotation of the first member, to thereby measure the rotational torque that acts on the first member.

### SUMMARY

In recent years, it has been demanded to develop a technique of measuring a rotational torque of an infinitely rotating rotator such as a wheel. However, with the configuration disclosed in Patent Document 1 above, the torque sensor is infinitely rotated together with a measured target. As a result, a sensor cable attached to the torque sensor is wound around the periphery of the rotating shaft, which makes it difficult to correctly detect the torque.

Further, the torque sensor arranged between the input shaft and the output shaft is susceptible to the effects of other axis components. Therefore, there is also a problem that it may be impossible to accurately detect a torque value of only a desired rotational axis component.

In view of the above-mentioned circumstances, there is a need for providing a torque detection apparatus and a robot apparatus, which are capable of correctly detecting a rotational torque of an infinitely rotating rotator.

According to according to an embodiment of the present disclosure, there is provided a torque detection apparatus including a base portion, a drive portion, and a detection portion.

The drive portion includes a rotor having a main axis in a direction of a first axis, and a stator configured to rotate the rotor around the main axis.

The detection portion includes a strain body and a detection element. The strain body includes a first end portion to be fixed to the base portion and a second end portion to be fixed to the rotor, and is arranged concentrically with the rotor. The detection element is provided to the strain body so as to detect a strain of the strain body around the first axis with respect to the base portion.

In the torque detection apparatus, the drive portion rotates the rotor around the first axis through the stator. When the rotor is rotated, the stator receives a driving reaction force to a direction opposite to a rotational direction of the rotor. Then, the detection portion detects the driving reaction force of the rotor, which acts on the stator, to thereby detect a rotational torque of the rotor. That is, the strain body arranged between the base portion and the stator is deformed around the first axis by the driving reaction force acting on the stator, and the detection element detects the strain of the strain body. As described above, without rotating the detection portion together with the rotor, the rotational torque of the rotor is detected. Thus, rotational torque of the infinitely rotating rotor can be correctly detected.

Typically, for the drive portion, a motor (electrical motor) is used. In addition to this, for the drive portion, an actuator such as a rotary cylinder that rotates the rotor using a fluid pressure such as a pneumatic pressure or a hydraulic pressure as a drive medium can be applied.

The torque detection apparatus may further include a frame body. The frame body is fixed to the base portion so as to support the stator to be rotatable around the first axis.

With this configuration, the stator is supported via the frame body to the base portion so as to be rotatable, and hence it is possible to effectively eliminate the effects of axis components other than the rotational torque around the first axis with respect to the stator. Thus, only the rotational torque around the first axis can be correctly detected.

The torque detection apparatus may further include a rotary member. The rotary member is arranged around the frame body so as to be rotatable around the first axis due to rotation of the rotor.

The rotary member is arranged around the frame, and hence it is possible to achieve a reduction of the size of the torque detection apparatus along the direction of the first axis. As a result, other axis components can be eliminated more easily, and hence it is possible to prevent the detection accuracy from being reduced.

The rotary member is, for example, a tire. In this case, the torque detection apparatus is configured as a wheel that rotates the tire. Thus, it is possible to detect a rotational torque of the infinitely rotating wheel correctly and with high accuracy. In addition, the rotational driving of the wheel can be controlled with high accuracy.

The configuration of the strain body constituting the detection portion is not particularly limited, and various configurations can be employed. For example, the strain body may include a shaft-like portion including the first end portion and the second end portion at both ends thereof. In this case, the detection element is provided to the shaft-like portion.

Alternatively, the strain body may include a first annular body, a second annular body, and a connection portion. The first annular body includes the first end portion, and is formed to have a first diameter. The second annular body includes the second end portion and is formed to have a second diameter different from the first diameter. The connection portion is configured to connect between the first annular body and the second annular body. In this case, the detection element is provided to the connection portion.

According to another embodiment of the present disclosure, there is provided a robot apparatus including a main body, a drive portion, a detection portion, and a wheel.

The drive portion includes a rotor having a main axis in a direction of a first axis, and a stator configured to rotate the rotor around the main axis.

The detection portion includes the strain body and the detection element. The strain body includes a first end portion to be fixed to the main body and a second end portion to be fixed to the rotor, and is arranged concentrically with the rotor. The detection element is provided to the strain body so as to detect a strain of the strain body around the first axis with respect to the main body.

The wheel is coupled to the rotor so as to rotate around the first axis due to rotation of the rotor, to thereby move the main body.

In the robot apparatus, the drive portion drives the rotor, to thereby rotate the wheel around the first axis. When the wheel is rotated, the stator receives a driving reaction force to a direction opposite to a rotational direction of the wheel. Then, the detection portion detects the driving reaction force of the wheel, which acts on the stator, to thereby detect a rotational torque of the wheel. That is, the strain body arranged between the main body and the stator is deformed around the first axis by the driving reaction force acting on the stator, and the detection element detects the strain of the strain body. As described above, without rotating the detection portion together with the wheel, the rotational torque of the wheel is detected. Thus, rotational torque of the infinitely rotating wheel can be correctly detected.

According to the embodiments of the present disclosure, the rotational torque of the infinitely rotating rotator can be correctly detected.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a front view of a robot apparatus according to an embodiment of the present disclosure;

FIG. 2 is a sectional view of a wheel including a torque detection apparatus according to the embodiment of the present disclosure;

FIG. 3 is an exploded perspective view of the wheel;

FIG. 4 is a perspective view showing a shape of a strain body constituting the torque detection apparatus;

FIG. 5 is a perspective view showing another configuration example of the strain body;

FIG. 6 is a front view showing a robot apparatus according to another embodiment;

FIG. 7 is a back view of the robot apparatus according to another embodiment;

FIG. 8 is a plan view of the robot apparatus according to another embodiment;

FIG. 9 is a bottom view of the robot apparatus according to another embodiment;

FIG. 10 is a right side view of the robot apparatus according to another embodiment; and

FIG. 11 is a left side view of the robot apparatus according to another embodiment.

### DETAILED DESCRIPTION OF EMBODIMENTS

Hereinafter, embodiments of the present disclosure will be described with reference to the drawings.

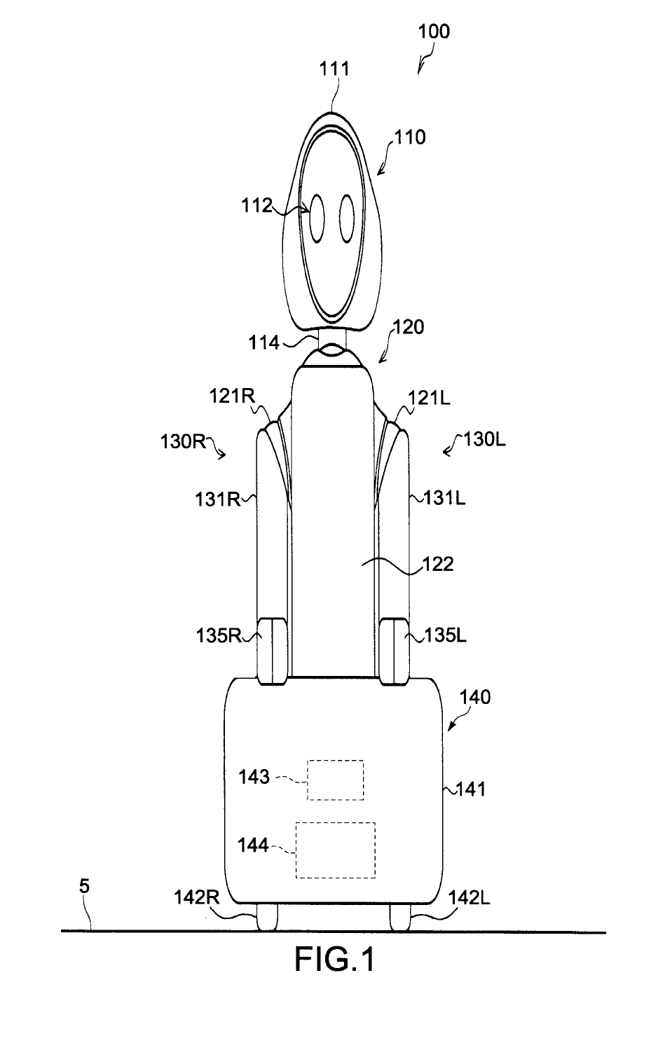

FIG. 1 is a front view schematically showing a robot apparatus according to an embodiment of the present disclosure. A robot apparatus 100 according to this embodiment is configured as a humanoid service robot capable of moving on the ground (floor) 5 with a plurality of wheels 142R, 142L.

### [Robot Apparatus]

The robot apparatus 100 includes a head part 110, a body part 120, left and right arm parts 130L, 130R, and a moving part 140.

The head part 110 includes a head part main body 111, a camera 112 for capturing the surroundings as image information, and a neck 114 to be coupled to the body part 120. The body part 120 includes a body part main body 122 and left and right shoulder 121L, 121R to be coupled to the left and right arm parts 130L, 130R, respectively.

The left and right arm parts 130L, 130R includes first arms 131L, 131R, second arms coupled to the first arms, and hands 135L, 135R coupled to the second arms, respectively. In FIG. 1, so that the hands 135L, 135R are positioned in front of the robot, the second arms are bent with respect to the first arms 131L, 131R to a front direction by approximately 90°. Therefore, in FIG. 1, the second arms are positioned behind the hands 135L, 135R, respectively.

The moving part 140 includes a moving part main body 141 coupled to the body part 120 and a plurality of wheels 142L, 142R. The moving part main body 141 houses a driving power supply (for example, battery) 143 for the wheels 142L, 142R, and a controller 144 for drive control, and the like. The driving power supply 143 and the controller 144 may also serve as a driving power supply and a controller for each of actuators constituting the head part 110, the body part 120, and articulation parts of the arm parts 130L, 130R.

The wheels 142L, 142R are provided to the bottom of the moving part main body 141, for example, at four positions of front behind left and right. All of the wheels 142L, 142R or at least one pair of the left and right wheels 142L, 142R include a rotational driving source. In addition, among them, at least one wheel includes a torque detection mechanism (torque detection apparatus) for detecting a rotational torque of that wheel. The controller 144 measures a rotational torque according to a signal output from the torque detection mechanism, and controls a driving torque of the wheels 142L, 142R.

### [Torque Detection Mechanism]

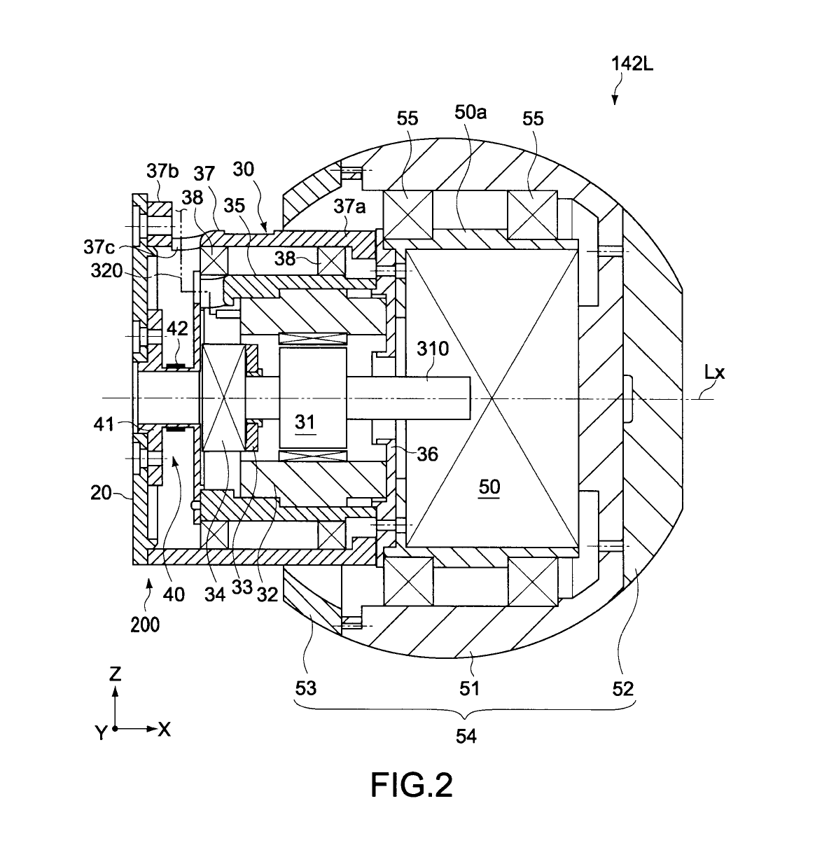

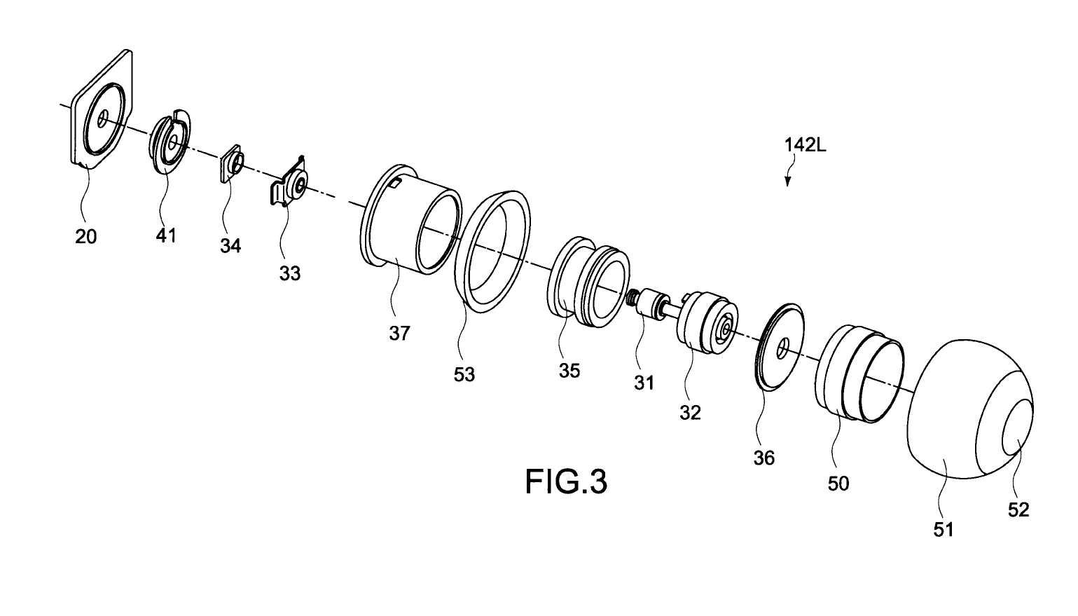

Hereinafter, the description will be made of a configuration of the wheel including the torque detection mechanism with reference to FIG. 2 and FIG. 3. Here, an example in which the torque detection mechanism is applied to the wheel 142L will be described.

FIG. 2 is a sectional view showing an inner structure of the wheel 142L, and FIG. 3 is an exploded perspective view. In FIG. 2, the X-axis direction and the Y-axis direction denote horizontal directions orthogonal to each other, and the Z-axis direction denotes a vertical direction.

The torque detection mechanism 200 includes a base portion 20, a driving portion 30, and a detection portion 40. The torque detection mechanism 200 detects the rotational torque of the wheel 142L, and outputs its detection signal to the controller 144 installed in the moving part main body 141.

The base portion 20 constitutes a part of the moving part main body 141, and supports the wheel 142L so as to be rotatable. The base portion 20 functions as a static system being a reference for detecting the rotational torque of the wheel 142L in the torque detection mechanism 200.

The drive portion 30 includes a rotor 31 and a stator 32. The drive portion 30 has a function of driving the wheel 142L. In this embodiment, the drive portion 30 is constituted of a motor (electrical motor). The rotor 31 includes a driving shaft 310 extending along an axis Lx (main axis, first axis) parallel to the X-axis direction. The stator 32 rotates the rotor 31, that is, the driving shaft 310 around the main axis Lx. The kind of the motor is not particularly limited. In this embodiment, the stator 32 includes an exciting coil, and the rotor 31 includes a permanent magnet. The exciting coil is electrically connected via a cable 320 to the controller 144.

The drive portion 30 includes a bearing member 33 and an encoder 34. The bearing member 33 supports the driving shaft 310 on the base portion 20 side so as to be rotatable. The encoder 34 detects an angle of rotation or an amount of rotation of the driving shaft 310. The encoder 34 is electrically connected via a cable (not shown) to the controller 144.

Further, the drive portion 30 includes a first motor frame 35 having a tubular shape and housing the stator 32. The stator 32 is supported by the first motor frame 35 integrally. One end of the first motor frame 35 is mounted via the strain body 41 of the detection portion 40 to the base portion 20. The other end of the first motor frame 35 is covered with a motor cap 36. The motor cap 36 has a through-hole at its center, and the driving shaft 310 is inserted into the through-hole.

The drive portion 30 further includes a second motor frame 37 (frame body) provided on a side of the outer periphery of the first motor frame 35. The second motor frame 37 includes a tubular portion 37a that houses the first motor frame 35 and a fixed end portion 37b to be fixed on the base portion 20.

Between the tubular portion 37a and the outer periphery of the first motor frame 35, there is provided a bearing member 38. The first motor frame 35 is supported by the second motor frame 37 so as to be rotatable. The fixed end portion 37b has a substantially annular flange shape at one end on the base portion 20 side of the tubular portion 37a. The fixed end portion 37b is fixed to the base portion 20 with a plurality of screw members.

It should be noted that, in the second motor frame 37, there is formed a cutout 37c for pulling out wiring cables for the stator 32, the encoder 34, a detection element 42 of the detection portion 40, and the like to the outside of the drive portion 30.

The wheel 142L includes a reducer 50 to be coupled to the driving shaft 310 and a rotary member 54 provided on an output side of the reducer 50. The reducer 50 is constituted of a planetary gear, which reduces the rotational speed of the driving shaft 310 at a predetermined reduction ratio, to thereby generate a predetermined rotational torque. The rotary member 54 is an assembly of a first member 51, a second member 52, and a third member 53, which form a substantially spherical tire.

The first member 51 is coupled to an output side of the reducer 50, and is supported via a bearing member 55 so as to be rotatable around a gear case 50a supporting the reducer 50. Here, the gear case 50a is integrally fixed to the motor cap 36 through screw members. The second member 52 and the third member 53 are coupled to ends of the first member 51, respectively. Although the rotary member 54 is formed of a rubber material, another material such as a plastic material may be used for forming the rotary member 54. The rotary member 54 is rotatable around the axis Lx due to driving of the drive portion 30. The shape of the rotary member 54 is not limited to the spherical shape as shown in the drawing, but a cylindrical shape may be employed.

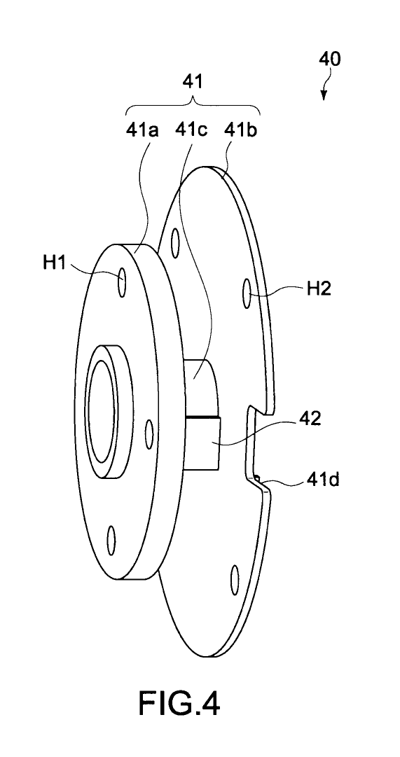

The detection portion 40 includes the strain body 41 and the detection element 42. FIG. 4 is a perspective view showing a configuration example of the strain body 41.

The strain body 41 is, for example, formed of a metal material such as a soft steel or an aluminum alloy, and is provided between the base portion 20 and the stator 32. The strain body 41 includes a first flange portion 41a to be fixed to the base portion 20, a second flange portion 41b to be fixed to the stator 32 of the drive portion 30, and a shaft-like portion 41c that couples the first flange portion 41a and the second flange portion 41b to each other.

The first flange portion 41a corresponds to a first end portion that fixes one end side of the shaft-like portion 41c to the base portion 20, and has a plurality of screw holes H1 formed concentrically with the shaft-like portion 41c. The second flange portion 41b corresponds to a second end portion that fixes the other end of the shaft-like portion 41c to the stator 32, and has a plurality of screw holes H2 formed concentrically with the shaft-like portion 41c. The strain body 41 is fixed to the base portion 20 and the first motor frame 35 by screwing through the screw holes H1, H2. In this embodiment, the second flange portion 41b is formed to have a diameter larger than that of the first flange portion 41a, and the screw holes H2 are formed in a concentric circle having a diameter larger than a diameter of a concentric circle of the screw holes H1. With this configuration, a reaction force of the motor of the drive portion 30 can be easily transmitted to the shaft-like portion 41c.

The shaft-like portion 41c has a hollow-cylinder shape, and arranged concentrically with the rotor 31. The inner diameter, the outer diameter, the length, and the like of the shaft-like portion 41c can be correctly set depending on a desired detection sensitivity or the like.

It should be noted that, in the second flange portion 41b, there is formed a cutout 41d for pulling out the wiring cables for the stator 32, the encoder 34, and the like to the outside of the drive portion 30.

The detection element 42 is attached to the shaft-like portion 41c of the strain body 41. The detection element 42 serves to detect a strain of the shaft-like portion 41c around the axis Lx. Typically, a strain gauge that measures an amount of deformation on the basis of a change of electrical resistance. In addition to this, for example, an element that measures the amount of deformation on the basis of a change of magnetic properties may be used as the detection element.

A single detection element 42 may be used or a plurality of detection elements 42 may be used. In the case where the plurality of detection elements 42 are used, the detection elements 42 are attached at a plurality of positions in the periphery of the shaft-like portion 41c, the plurality of positions being symmetrical with respect to the shaft center. For example, when two pairs of detection elements that are opposed to each other while sandwiching the shaft center are bridge-connected to each other, a four-gauge bridge (Wheatstone bridge) can be configured.

Each of the detection elements 42 is electrically connected via a wiring cable (not shown) to the controller 144. The controller 144 calculates the amount of strain of the shaft-like portion 41c on the basis of a detection signal of each of the detection elements 42, to thereby measure the rotational torque of the wheel 142L.

### [Operation Example]

Next, the description will be made of an operation of the wheel 142L including the torque detection mechanism 200 configured in the above-mentioned manner.

When the stator 32 of the drive portion 30 receives an input of a driving signal from the controller 144, the stator 32 of the drive portion 30 generates a rotational driving force by which the rotor 31 and the driving shaft 310 are rotated around their axis. The reducer 50 reduces a rotational speed, which has been input via the driving shaft 310, at a predetermined reduction ratio, to thereby generate a rotational driving force converted into a predetermined rotational torque. The output of the reducer 50 is transmitted to the rotary member 54, to thereby rotate the rotary member 54 around the axis Lx of the driving shaft 310.

When the stator 32 rotates the rotor 31, the stator 32 receives a driving reaction force to a direction opposite to a rotational direction of the rotor 31. Then, the detection portion 40 detects the driving reaction force from the rotor 31, which acts on the stator 32, to thereby detect a rotational torque of the rotor 31. That is, the strain body 41 arranged between the base portion 20 and the stator 32 is deformed around the axis Lx due to the driving reaction force acting on the stator 32, and the detection element 42 detects the strain of the strain body 41.

The controller 144 calculates the rotational torque of the wheel 142L on the basis of the output of the detection element 42. The calculation method is not particularly limited, and for example, the following expression is used for the calculation.

T=τ*Zp (1)

Zp=n{(d₂4−d₁⁴)d₂}/16 (2)

τ=ε*E/(1+ν) (3)

Where, T denotes the rotational torque, τ denotes a shear stress, Zp denotes a polar section modulus, d₁ denotes the inner diameter of the shaft-like portion 41c, d₂ denotes the outer diameter of the shaft-like portion 41c, ε denotes the strain, E denotes a longitudinal elastic modulus of the shaft-like portion 41c, and ν denotes Poisson's ratio.

As described above, in the torque detection mechanism 200 of this embodiment, without rotating the detection portion 40 together with the rotor 31, the rotational torque of the rotor 31 is detected. Thus, the wiring cable to be connected to the detection element 42 can be prevented from being wound and broken around the axis Lx, and the rotational torque of the infinitely rotating wheel 142L can be correctly detected.

Further, the drive portion 30 is fixed via the second motor frame 37 to the base portion 20, and hence the strain body 41 can detect only the rotational torque around the axis Lx with high accuracy without being influenced by axis components other than the axis Lx. It should be noted that the first motor frame 35 (stator 32) is supported via the bearing member 38 so as to be rotatable around the axis Lx with respect to the second motor frame 37, and hence the rotation of the stator 32 due to the driving reaction force is prevented from being disturbed by the second motor frame 37.

As described above, according to this embodiment, it is possible to correctly detect the rotational torque of the infinitely rotating wheel 142L. Thus, the movement control of the robot apparatus 100 can be performed with high accuracy. Further, it is also possible to detect a rotational torque that acts on the wheel 142L in a halting state, and hence it is possible to cause the robot apparatus 100 to perform a predetermined operation depending on the magnitude of the rotational torque.

Further, when instead of installing the above-mentioned torque detection mechanism 200 only in the wheel 142L, for example, the detection mechanisms 200 are installed in all of the wheels, a turning operation of the robot apparatus 100 becomes easy, and hence a mobility thereof can be improved.

Although the embodiment of the prevent disclosure is described above, the present disclosure is not limited thereto, but various modification can be made on the basis of the technical idea of the present disclosure.

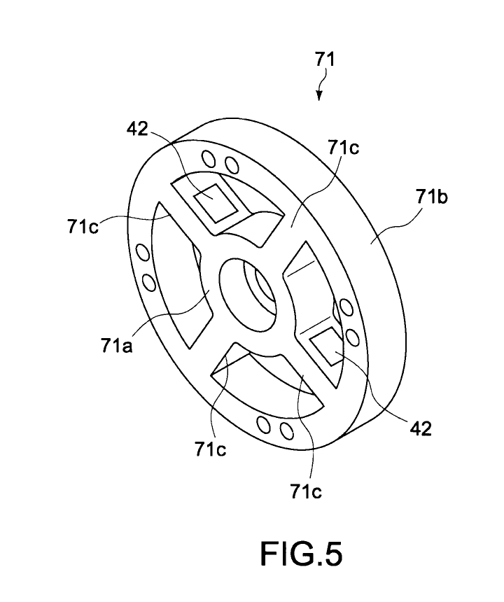

For example, although in the above-mentioned embodiment, as the detection portion 40, the strain body 41 having the shape as shown in FIG. 4 is used, in place of this, a strain body 71 having a shape as shown in FIG. 5 may be used. The strain body 71 includes a first annular body 71a, a second annular body 71b, and a connection portion 71c.

The first annular body 71a is formed to have a first diameter, and includes a first end portion (end surface) to be fixed to the base portion 20. The second annular body 71b is formed to have a second diameter, and has a second end portion (end surface) to be fixed to the first motor frame 35. The first annular body 71a and the second annular body 71b are arranged concentrically with each other. In this embodiment, the second annular body 71b is formed to have a diameter larger than that of the first annular body 71a.

The connection portion 71c connects the first annular body 71a and the second annular body 71b to each other. In this embodiment, four connection portions 71c are provided radially. Of the plurality of connection portions 71c, predetermined connection portions 71c are provided with the detection elements 42. Each of the connection portions 71c is deformed when the second annular body 71b receives a rotational torque with respect to the first annular body 71a in a circumferentially. The deformation of those connection portions 71c is detected by the detection elements 42, and is output to the controller 144.

Even with the strain body 71 having such a configuration, it is possible to efficiently detect the driving reaction force of the rotor 31, which acts on the stator 32.

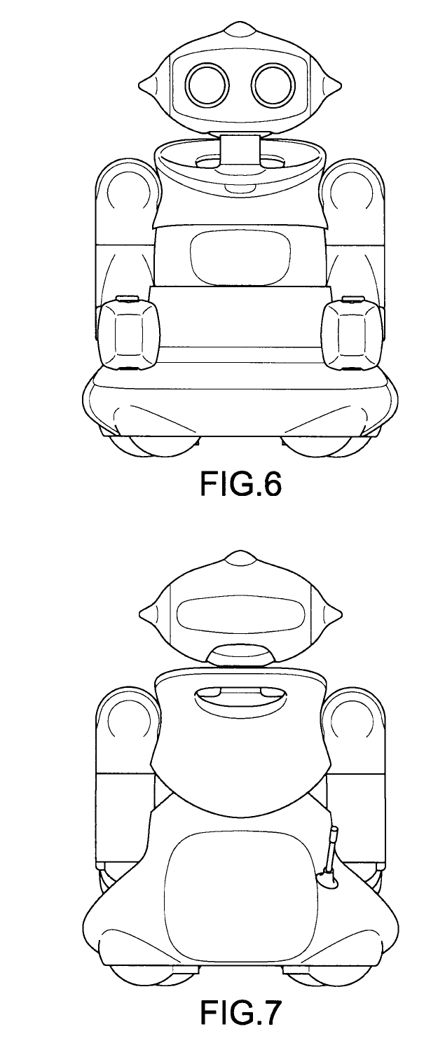

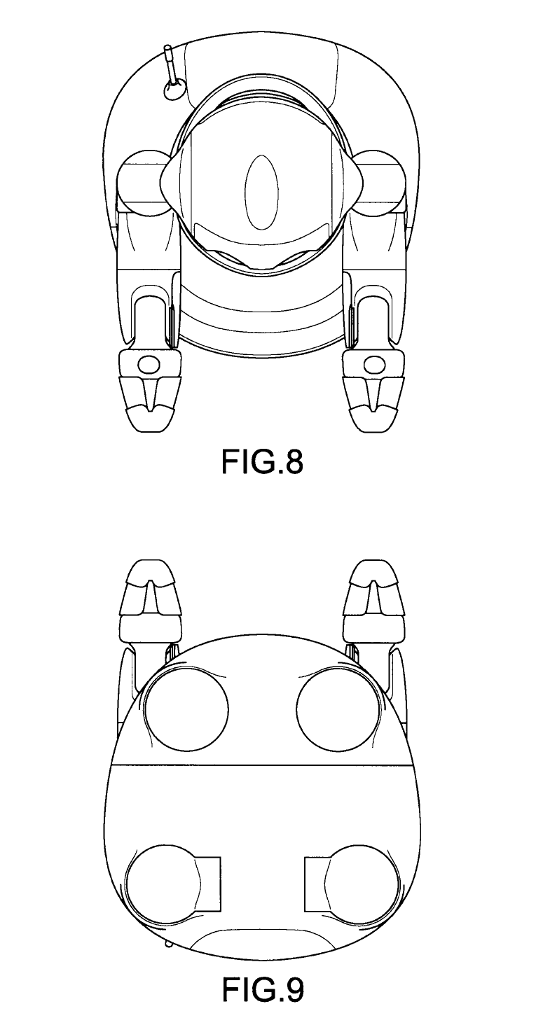

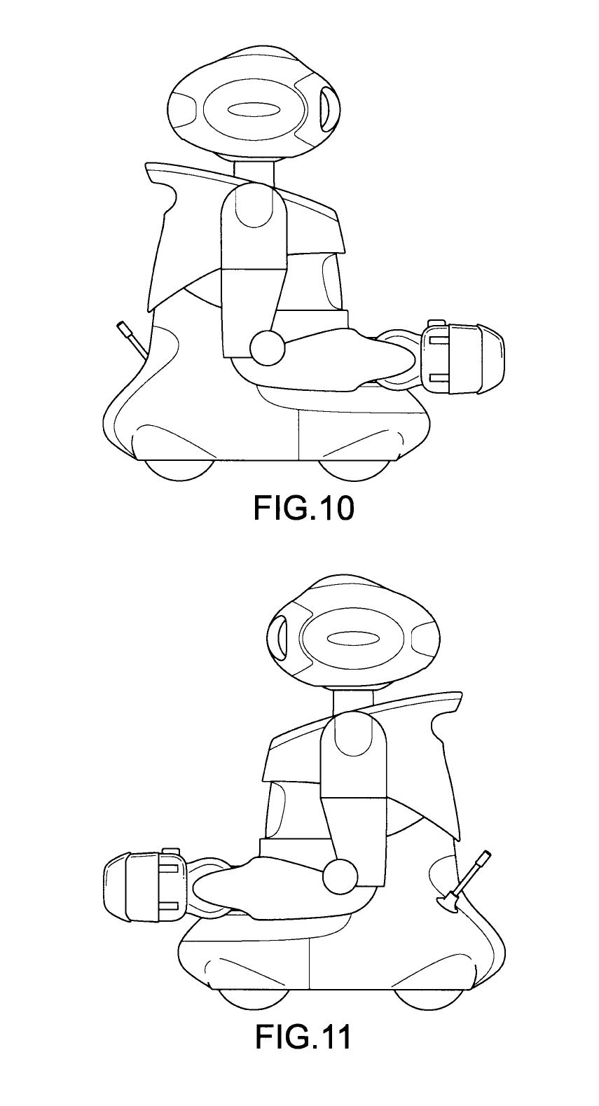

The service robot is not limited to the embodiment as shown in FIG. 1. For example, an embodiment as shown in FIG. 6 to FIG. 11 may be employed. Here, FIG. 6 is a front view, FIG. 7 is a back view, FIG. 8 is plan view, FIG. 9 is a bottom view, FIG. 10 is a right side view, and FIG. 11 is a left side view.

Further, although in the above-mentioned embodiment, the service robot as the robot apparatus 100 is described as one example, the present disclosure is not limited thereto. The present disclosure can be also applied to an unmanned vehicle robot, or the like. In addition, although in the above-mentioned embodiment, the example in which the present disclosure is applied for detecting the torque of the infinitely rotating rotary members such as the wheels is described, the present disclosure can be also applied for detecting the torque of any infinitely rotating rotary members such as the articulation parts of the robot.

The present disclosure contains subject matter related to that disclosed in Japanese Priority Patent Application JP 2010-186887 filed in the Japan Patent Office on 24 Aug. 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A torque detection apparatus, comprising:
a base portion;
a drive portion including
a rotor having a main axis in a direction of a first axis, and
a stator configured to rotate the rotor around the main axis; and
a detection portion including
a strain body including
a first end portion to be fixed to the base portion, and
a second end portion to be fixed to the rotor, the strain body being arranged concentrically with the rotor, and
a detection element to be provided to the strain body so as to detect a strain of the strain body around the first axis with respect to the base portion.

2. The torque detection apparatus according to claim 1, further comprising a frame body to be fixed to the base portion so as to support the stator to be rotatable around the first axis.

3. The torque detection apparatus according to claim 2, further comprising a rotary member to be arranged around the frame body so as to be rotatable around the first axis due to rotation of the rotor.

4. The torque detection apparatus according to claim 3, wherein the rotary member includes a tire.

5. The torque detection apparatus according to claim 1, wherein
the strain body includes a shaft-like portion including the first end portion and the second end portion at both ends thereof, and
the detection element is provided to the shaft-like portion.

6. The torque detection apparatus according to claim 1, wherein
the strain body includes
a first annular body including the first end portion and being formed to have a first diameter,
a second annular body including the second end portion and being formed to have a second diameter different from the first diameter, and
a connection portion configured to connect between the first annular body and the second annular body, and
the detection element is provided to the connection portion.

7. A robot apparatus, comprising:
a main body;
a drive portion including
a rotor having a main axis in a direction of a first axis, and
a stator configured to rotate the rotor around the main axis;
a detection portion including
a strain body including
a first end portion to be fixed to the main body, and
a second end portion to be fixed to the rotor, the strain body being arranged concentrically with the rotor, and
a detection element to be provided to the strain body so as to detect a strain of the strain body around the first axis with respect to the main body; and
a wheel to be coupled to the rotor so as to rotate around the first axis due to rotation of the rotor, to thereby move the main body.
